(19) United States
(12) Patent Application Publication
(10) Pub. No.: US 2026/0213598 A1
(43) Pub. Date: Jul. 23, 2026

(54) ELECTRIC MACHINE HAVING A STATOR AND STRANDED CONDUCTOR WINDING

(71) Applicant: Schaeffler Technologies AG & Co. KG, Herzogenaurach (DE)

(72) Inventor: Dennis Kuhl, Buhl (DE)

(73) Assignee: Schaeffler Technologies AG & Co. KG, Herzogenaurach (DE)

(21) Appl. No.: 19/140,415

(22) PCT Filed: Dec. 14, 2023
(86) PCT No.: PCT/DE2023/100973

§ 371 Date: Jun. 18, 2025

(30) Foreign Application Priority Data
Dec. 19, 2022 (DE) 102022133840.1

(51) Int. Cl. H02K 3/32; H02K 1/14; H02K 3/28

(52) U.S. Cl. CPC H02K 3/325; H02K 1/14; H02K 3/28; H02K 2213/03

(57) ABSTRACT

An electric machine having a stator which has a conductor, wherein the conductor is designed as a stranded conductor having a plurality of strands and forms at least one coil by means of turns and is surrounded on the outer side by a basic insulation.

### CROSS-REFERENCE TO RELATED APPLICATIONS

This application is the U.S. National Phase of PCT Appln. No. PCT/DE2023/100973, filed Dec. 14, 2023, which claims the benefit of German Patent Appln. No. 102022133840.1, filed Dec. 19, 2022, the entire disclosures of which are incorporated by reference herein.

### TECHNICAL FIELD

The disclosure relates to an electric machine having a stator that has a conductor.

### BACKGROUND

Coil wires are used in electric machines. The coil wires are penetrated by a stray magnetic field. This inevitably leads to eddy current losses in the conductors. To minimize these eddy current losses, the cross-section of the coil wires can be reduced. Conversely, the number of turns is usually increased in order to achieve a sufficient total current in the stator slots. To maintain the voltage limit, a plurality of coils with a high number of turns are connected in parallel in the stator. Opposite coils are connected in series. Owing to the large number of coils and turns formed on the stators, a very large wiring effort is required. For this reason, only classic copper wires are used for the turns in series production. As the wiring is very complex, this leads to a very high design complexity and a large assembly effort. Furthermore, the parallel circuits already mentioned lead to additional circulating current losses. This is owing to the fact that not all coils and their connections as well as the magnets may be precisely symmetrical due to manufacturing or design constraints. However, these additional losses cannot be measured separately.

The problem with using classic copper wires as conductors is that they have a very large insulation component. Due to the high number of turns in the coil, the overall insulation component is correspondingly very large. Therefore, the coil is also largely made of insulating material, which increases the cross-section of the coil.

### SUMMARY

The object of the present disclosure is to eliminate or at least (partially) alleviate the disadvantages mentioned. The focus here is on eddy current losses, which have to be minimized. Circulating current losses must also be eliminated.

This is solved in an electric machine of the type in question in that the conductor is designed as a stranded conductor comprising a plurality of strands, and at least one coil is formed by means of (e.g., two, three, four, five, six or more) turns and is surrounded on the outer side by a basic insulation. The advantage of stranded conductors is that they can minimize eddy current losses. With a small number of turns, the basic insulation, i.e., the insulation on the outer side of the stranded conductors, can be configured with thin wall thicknesses. This has the advantage that there is no huge installation space disadvantage. As a result, problematic slot insulation can be dispensed with. It is advantageous if the basic insulation has a wall thickness of between 150 μm and 500 μm.

Advantageous embodiments are claimed in the dependent claims and are explained in more detail below.

Furthermore, at least one of the strands or all strands can each be surrounded by their own additional insulation, with it being preferred that the individual strands are systematically stranded with one another in at least one stage. If the stranded conductor already has basic insulation, the additional insulation of the strand or of all the strands can be reduced to a minimum.

Furthermore, the conductor can be a plurality of conductors, the number of conductors corresponding at least or exactly to the number of desired phases, with each conductor forming at least one coil. If the number of desired phases is kept low, the number of conductors is also low, which reduces the wiring effort and the installation space.

In another advantageous embodiment, the number of conductors can be a multiple of the number of desired phases. In addition, the number of conductors can be twice the number of desired phases. Furthermore, the number of conductors can correspond to the number of desired phases

It is particularly advantageous if the additional insulation has a wall thickness of between 1 μm and 20 μm. The wall thickness of the additional insulation depends on the selected manufacturing process.

There can also be 12 coils per phase.

It is advantageous if the windings are wound on a single strand. A plurality of coils can be wound from a conductor to form turns. This means that only one conductor is required per phase, which minimizes the wiring effort.

It is also advantageous if all conductors of a phase are connected in series. The series connection ensures that the wiring effort is also kept low. In addition, the circulating current losses are eliminated by eliminating the parallel connection.

In addition, a slot length can be a multiple of a strand lay length, the length of the repeating twist pattern. This allows the induced voltages within the slot under the individual strands to be standardized and circulating currents in short-circuited strands to be reduced.

It is advantageous if 36 coils each with four turns are divided into two stator halves and three phases are formed by three conductors. The stator halves are arranged in such a way that a rotor is positioned between the two stator halves. By using only three conductors, the connection between the stator halves is reduced to a minimum. The conductors are transferred from the one stator half to the other stator half. This means that only one connection per phase is required between the stator halves. This reduces the amount of wiring required, and less installation space is used.

In a further advantageous embodiment, a plurality of coils can be separated into two coil halves, each with a half-integer number of turns, in order to implement the wiring between the two coil halves on the coil opposite the terminal.

In addition, one or more phases can be wired on the inner and/or outer diameter of the coils. Accordingly, the phases can be wired only on the inner diameter or only on the outer diameter or a portion of the phases is wired on the inner diameter and another portion on the outer diameter. A special feature of wiring on the inner diameter is that the first coil is configured with a non-integer number of turns, since the conductor fills the missing turns during the return, i.e., to continue the wiring to the other stator half.

Furthermore, the electric machine can be designed as an axial flux machine, in particular as a motor. The advantages of an axial flux machine are that it has a shorter axial length and improved efficiency compared to a radial flux machine. A higher torque is achieved with the same outer diameter. In addition, the lower iron volume of the active portion results in higher efficiency over a wider speed range.

It is particularly advantageous if the individual strands are twisted/stranded with one another in such a way that each of the strands is on the outside and inside of the conductor formed by the strands. This means that each strand can be supplied with coolant from the outside. This ensures a particularly thermally optimized winding.

Various advantageous embodiments of the disclosure are explained in more detail below with reference to drawings comprising figures.

### BRIEF DESCRIPTION OF THE DRAWINGS

In the drawings:

FIG. 1 shows an exploded view of an electric machine according to the disclosure;

FIG. 2 shows a sectional view of a part of a stator half in a first embodiment;

FIG. 3 shows a sectional view of a part of a stator half in a second embodiment;

FIG. 4 shows a schematic representation of the two stator halves with a first wiring option;

FIG. 5 shows a schematic representation of the two stator halves with a second wiring option.

The figures are merely schematic in nature and serve solely for understanding the disclosure. Identical elements are provided with the same reference signs. Features of the individual embodiments can be interchanged and used alternatively/cumulatively.

### DETAILED DESCRIPTION

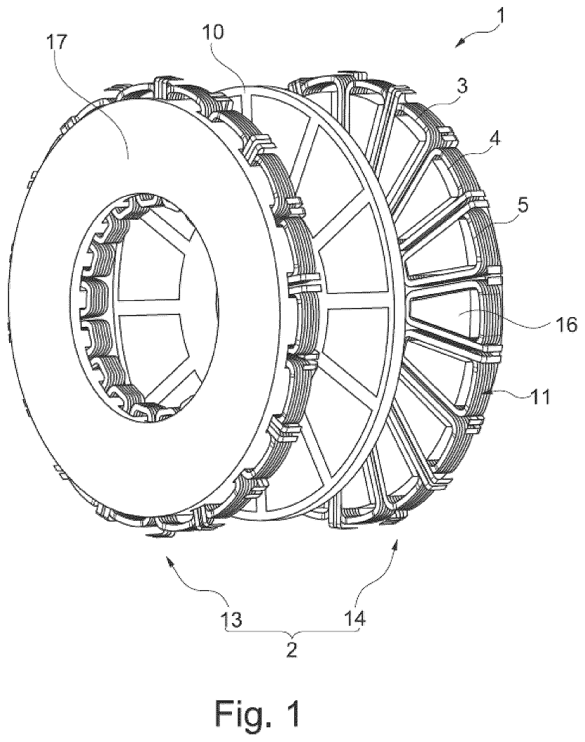

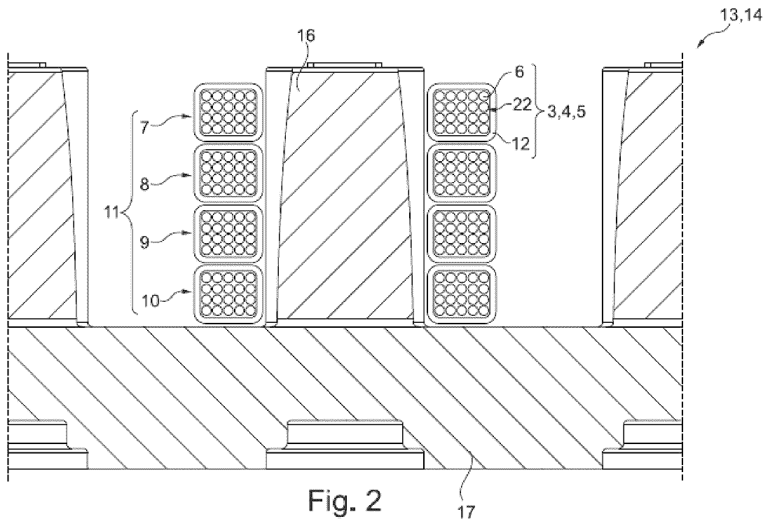

FIG. 1 shows an exploded view of an electric machine 1 according to the disclosure. The electric machine 1 has a stator 2, which has a conductor 3, 4, 5. The conductor 3, 4, 5 is formed using strands 6 (see FIG. 2). The conductor 3, 4, 5, designed here as a stranded conductor, has a plurality of strands 6. A coil 11 is formed by means of turns 7, 8, 9, 10 (shown in detail in FIG. 2), and the conductor 3, 4, 5 is surrounded on the outer side by a basic insulation 12 (shown in FIG. 2).

The stator 2 is divided into two stator halves 13, 14: a first stator half 13 and a second stator half 14. The first stator half 13 and the second stator half 14 are arranged in such a way that a rotor 15 is arranged between the two stator halves 13, 14 in the axial direction. The stator halves 13, 14 each have a plurality of stator teeth 16, which are arranged in the circumferential direction along the stator halves 12, 13. Each stator tooth 16 has a coil 11. The stator teeth are formed on a stator yoke 17, which mirrors the base of the stator half 13, 14.

FIG. 2 now shows a sectional view of a stator half 13, 14, in which a stator tooth 16 passes through the section. This sectional view can be used to describe the representation of the conductors 3, 4, 5 with the strands 6 in more detail. In the embodiment shown here, the coil 11 has a total of four turns 7, 8, 9, 10. The turns 7, 8, 9, 10 are designed as a single layer.

The conductor 3, 4, 5 shown here is a stranded conductor. The stranded conductor has a plurality of individual strands 6. The embodiment has a total of twenty strands 6 per conductor 3, 4, 5. The strands 6 are arranged in such a way that they are surrounded by the basic insulation 12 when arranged together. Five strands 6 are shown one above the other in the radial direction and a total of four strands 6 are arranged one after the other in the axial direction. Accordingly, the conductor 3, 4, 5 has a total of twenty strands 6. The strands 6 each have an additional insulation 22.

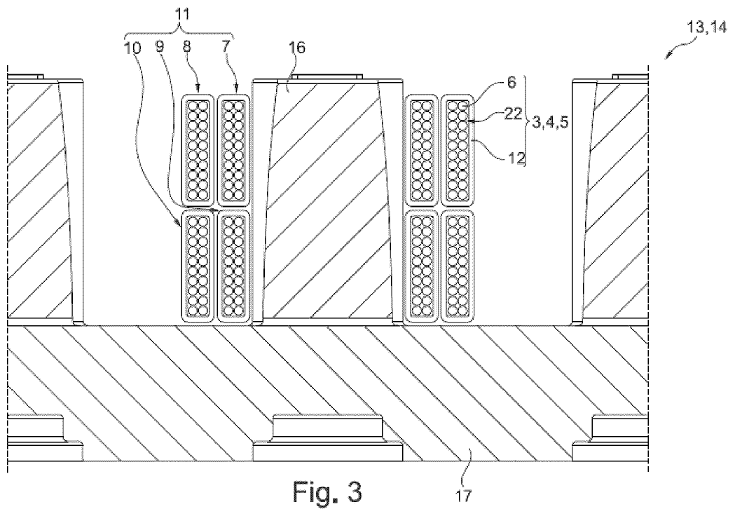

FIG. 3 now shows the same sectional view as in FIG. 2. Compared to FIG. 2, the arrangement of the turns 7, 8, 9, 10 and the strands 6 in the conductor 3, 4, 5 is different. In the embodiment shown, the total of four turns 7, 8, 9, 10 are not arranged in a single layer, but two turns 7, 8, 9, 10 are wound one above the other, i.e., a two-layer design. In the conductor 3, 4, 5, the strands 6 are arranged in such a way that a total of ten strands 6 are arranged next to each other in the axial direction and two strands 6 are arranged in the radial direction. The total number of strands 6 in the conductor 3, 4, 5 is also twenty strands 6 as in FIG. 2.

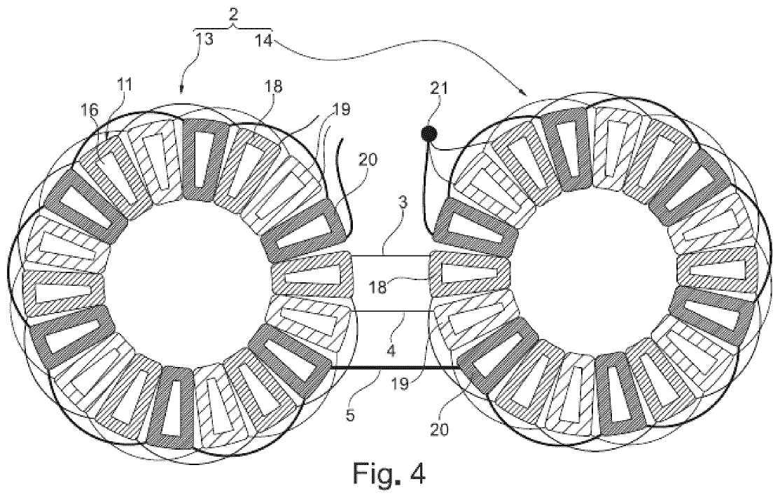

FIG. 4 now shows the wiring of the stator halves 13, 14. As already described in FIG. 1, the stator 2 is divided into two stator halves 13, 14. The wiring is designed such that the first stator half 13 and the second stator half 14 are connected via the conductors 3, 4, 5. In the embodiment shown, the stator halves 13, 14 are each designed with 18 coils 11. The stator 2 therefore has a total of 36 coils 11. The coils 11 are divided into a total of three phases 18, 19, 20. The coils 6 are arranged in the phases 18, 19, 20 in such a way that they are arranged alternately in the circumferential direction. In the case of 18 coils 11 per stator half 13, 14, a total of six coils 11 are shown per phase 18, 19, 20. In the embodiment shown, the conductors 3, 4, 5 are designed such that one conductor 3, 4, 5 per phase 18, 19, 20 is used for the winding of the coils 11. The conductors 3, 4, 5 of the respective phases 18, 19, 20 start at a terminal (not shown), from which each of the conductors 3, 4, 5 reaches a first stator tooth 16 and starts winding around the stator teeth 16. If the conductors 3, 4, 5 of the respective phases 18, 19, 20 are wound around all the stator teeth 16 of the first stator half 13, the conductor 3, 4, 5 leads to the second stator half 14, and the conductor 3, 4, 5 is wound around the stator teeth 16 in the same way as with the first stator half 13. If the three conductors 3, 4, 5 are also wound around their stator teeth 16 of the respective phases 18, 19, 20, the conductors 3, 4, 5 end in a star point 21. In the embodiment shown here, the individual coils 11 of the stator teeth 16 of the phases 18, 19, 20 are connected over the outer diameter of the stator halves 13, 14 via the conductor 3, 4, 5. The winding shown starts at a first stator tooth 16 and moves counterclockwise in the circumferential direction for the first stator half 13 and changes to a first stator tooth 16 of the second stator half 14 at the second stator half 14 and is also wound counterclockwise in the circumferential direction.

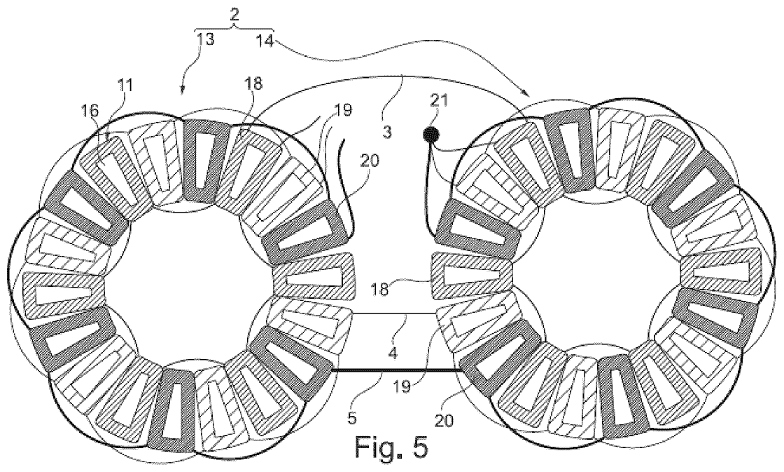

FIG. 5 now shows an alternative wiring compared to the wiring shown in FIG. 4. In the wiring shown here, all the phases 18, 19, 20 are no longer wound over the outer diameter of the stator halves 13, 14, but one phase 18 is wound over an inner diameter of the stator halves 13, 14. The other two phases 19, 20 are again wound over the outer diameter as in FIG. 4. If one of the phases 18, 19, 20 is wound over the inner diameter of the stator half 13, 14, the first stator tooth 16 must be wound with a non-integer number of turns 7, 8, 9, 10. If the conductor 3, 4, 5 now extends from the first stator tooth 16 to the other stator teeth 16 of the phase 18, 19, 20 on the first stator half 13, the missing turn 5 is rewound towards the second stator half 14 during the return path.

### LIST OF REFERENCE SIGNS

1 Electric machine
2 Stator
3 First conductor
4 Second conductor
5 Third conductor
6 Strand
7 First turn
8 Second turn
9 Third turn
10 Fourth turn
11 Coil
12 Basic insulation
13 First stator half
14 Second stator half
15 Rotor
16 Stator tooth
17 Stator yoke
18 First phase
19 Second phase
20 Third phase
21 Star point
22 Additional insulation

1. An electric machine comprising:
a stator which has a conductor, wherein the conductor is a stranded conductor having a plurality of strands and forms at least one coil with turns and is surrounded on an outer side by a basic insulation

2. The electric machine according to claim 1, wherein at least one of the strands is surrounded by its own additional insulation, wherein individual strands of the plurality of strands are systematically stranded with one another in at least one stage.

3. The electric machine according to claim 1, wherein the conductor is a plurality of conductors, wherein a number of conductors of the plurality of conductors corresponds at least or exactly to a number of desired phases and said conductor forms at least one coil.

4. The electric machine according to claim 1, wherein there are twelve coils per phase.

5. The electric machine according to claim 1, wherein a plurality of coils are wound from a conductor to form turns.

6. The electric machine according to claim 3, wherein all the conductors of a phase are connected in series.

7. The electric machine according claim 1, wherein a slot length is a multiple of a strand lay length.

8. The electric machine according to claim 1, wherein 36 coils, divided into two stator halves and three phases are formed by three conductors.

9. The electric machine according to claim 1, wherein a plurality of coils are separated into two coil halves, each having a half-integer number of turns, in order to implement the wiring between the two coil halves on the coil side opposite the terminal.

10. The electric machine according to claim 1, wherein the electric machine is as an axial flux machine.

11. A stator for an electric machine comprising:
a conductor, wherein the conductor is a stranded conductor having a plurality of strands and forms at least one coil with turns and is surrounded on an outer side by a basic insulation.

12. The stator according to claim 11, wherein at least one of the strands is surrounded by its own additional insulation, wherein individual strands of the plurality of strands are systematically stranded with one another in at least one stage.

13. The stator according to claim 11, wherein the conductor is a plurality of conductors, wherein a number of conductors of the plurality of conductors corresponds at least or exactly to a number of desired phases, and said conductor forms at least one coil.

14. The stator according to claim 11, wherein there are twelve coils per phase.

15. The stator according to claim 11, wherein a plurality of coils are wound from a conductor to form turns.

16. The stator according to claim 13, wherein all the conductors of a phase are connected in series.

17. The stator according to claim 11, wherein a slot length is a multiple of a strand lay length.

18. The stator according to claim 11, wherein 36 coils, divided into two stator halves and three phases, are formed by three conductors.

19. The stator according to claim 11, wherein a plurality of coils are separated into two coil halves, each having a half-integer number of turns, in order to implement the wiring between the two coil halves on the coil side opposite the terminal.
